(19) United States
(12) Patent Application Publication
(10) Pub. No.: US 2002/0137474 A1
(43) Pub. Date: Sep. 26, 2002

(54) Crystallite covering for cellular telephone

(76) Inventor: Yi-Shiuan Wu, Tamshui City (TW)

Correspondence Address: Yi-Shiuan Wu, PO Box 82-144, TAIPEI, TW

(21) Appl. No.: 09/814,959

(22) Filed: Mar. 23, 2001

(51) Int. Cl. H04B 1/38

(52) U.S. Cl. 455/90; 455/575; 455/550

(57) ABSTRACT

A crystallite covering used with a cellular telephone to isolate electromagnetic waves of the cellular telephone from contacting the user, includes a flexible fabric belt adapted to cover front and back sides of the cellular telephone, the flexible fabric belt having a plurality of crystallites of different sizes fixedly provided at a front sidewall thereof and arranged to show different designs and adapted to isolate electromagnetic waves of the cellular telephone, and a plurality of transverse strips of loop material fixedly provided at a back sidewall thereof and fastened to respective transverse strips of hook material of the cellular telephone.

### BACKGROUND OF THE INVENTION

The present invention relates to a covering for cellular telephone and, more particularly to a crystallite covering, which isolates electromagnetic waves of the cellular telephone from contacting the user.

Following fast development of technology and improvement of living standards, most people have an individual cellular telephone for communication. However, the use of a cellular telephone produces electromagnetic waves, which are harmful to the health of the human beings.

### SUMMARY OF THE INVENTION

The present invention has been accomplished to provide a crystallite covering for cellular telephone, which eliminates the aforesaid problem. It is one object of the present invention to provide a crystallite covering for cellular telephone, which isolates electromagnetic waves of the cellular telephone from touching the user. It is another object of the present invention to provide a crystallite covering for cellular telephone, which makes the cellular telephone attractive. According to one aspect of the present invention, the crystallite covering comprises a flexible fabric belt adapted to cover front and back sides of the cellular telephone, the flexible fabric belt having a plurality of crystallites of different sizes fixedly provided at a front sidewall thereof and adapted to isolate electromagnetic waves of the cellular telephone, and a plurality of transverse strips of loop material fixedly provided at a back sidewall thereof and fastened to respective transverse strips of hook material of the cellular telephone. According to another aspect of the present invention, the crystallites of the fabric belt are arranged to show different designs.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the preferred embodiment of the present invention.

FIG. 2 is an applied view of the present invention, showing the crystallite covering covered on a cellular telephone.

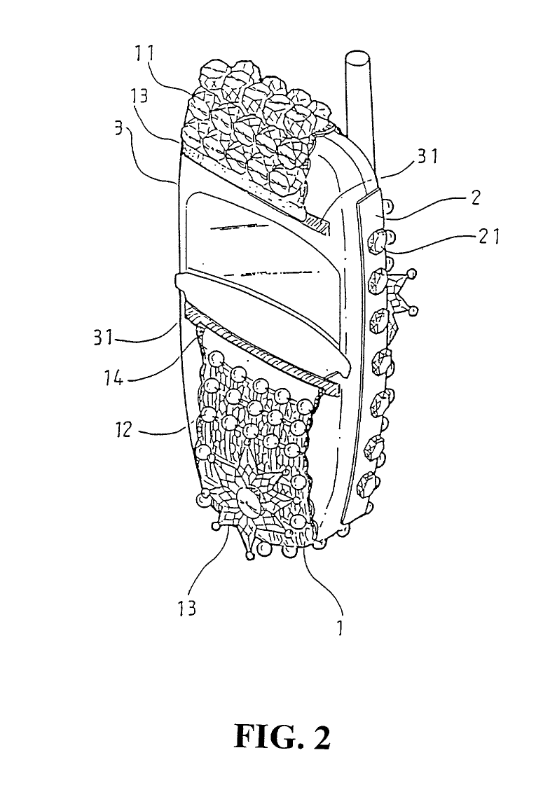

FIG. 3 is another applied view of the present invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

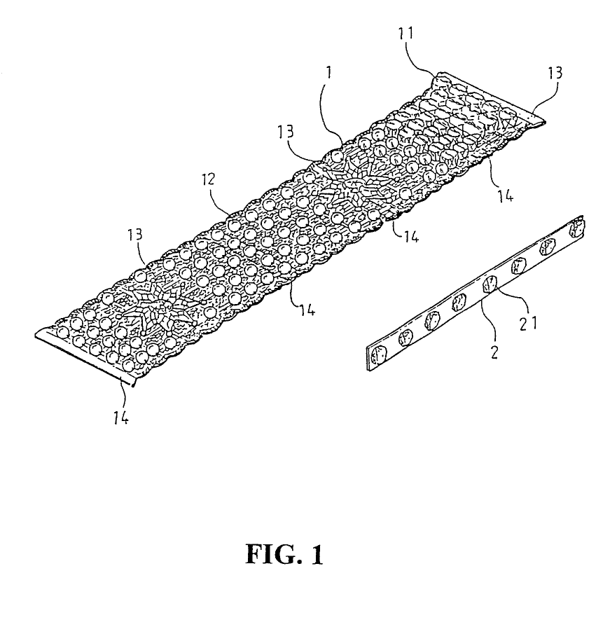

Referring to FIG. 1, a crystallite covering in accordance with the present invention is shown comprised of a flexible fabric belt 1, and a sticker strip 2. The fabric belt 1 comprises crystallites 11 and 12 of different sizes fixedly fastened to the front sidewall thereof and arranged to show different designs 13, and a plurality of narrow strips of loop material 14 fixedly transversely fastened to the back sidewall thereof. The sticker strip 2 comprises a plurality of crystallites 21 fixedly fastened to the front sidewall thereof. The back sidewall of the sticker strip 2 is covered with reusable adhesive means. The fabric belt 1 is adapted to cover the front and backsides of a cellular telephone. The sticker strip 2 is adapted to cover one lateral sidewall of the cellular telephone to which the fabric belt 1 is fastened. After installation, the fabric belt 1 and the sticker strip 2 isolate electromagnetic waves, protecting the user against electromagnetic waves during the operation of the cellular telephone. Crystallites are semiconductor crystals that produce a magnetic wave of frequency 8˜12 Hz, which is similar to the 9˜10 Hz X-wave of the brain of the human beings (the wave from human body is about 10˜15 Hz), but unlike the electromagnetic wave of 300 Hz˜3 GHz of regular cellular telephone. Because the wave amplitude is enhanced when similar waves encounter each other, or neutralized when waves of different frequencies encounter each other, the radiation of the crystallites 11, 12 and 21 is helpful to the user's health.

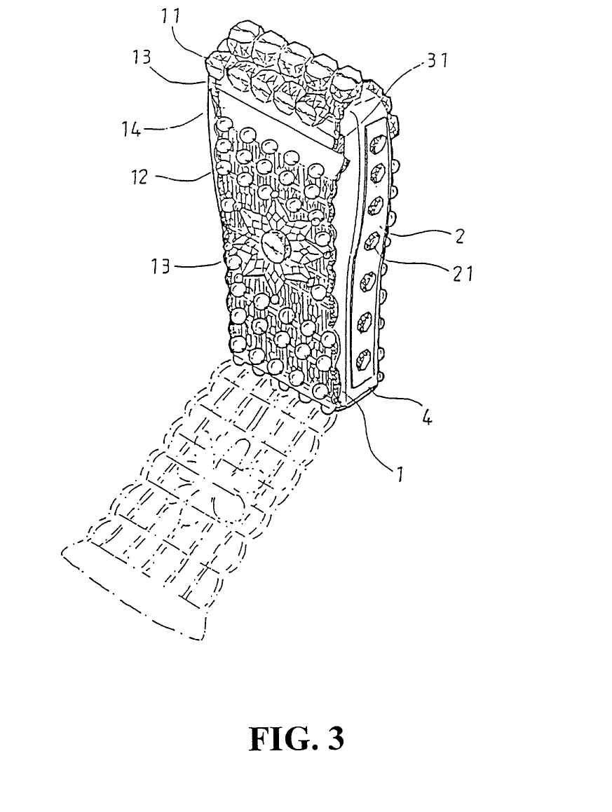

Referring to FIG. 3, when in use, the fabric belt 1 is covered on the front and back sides of the cellular telephone 3 by fastening the narrow strips of loop material 14 of the fabric belt 1 to respective strips of hook material 31 of the cellular telephone 3 (the strips of hook material 31 are fixedly fastened to the front and back sides of the cellular telephone 3 in advance), and then the sticker strip 2 is adhered to one lateral side of the cellular telephone 3 adjacent to the antenna of the cellular telephone 3. During operation of the cellular telephone 3, the crystallites 11, 12 and 21 isolate the electromagnetic waves of the cellular telephone 3 from contacting the user.

FIG. 4 shows the invention used with a different model of cellular telephone 4. When using the entry keys of the cellular telephone 4, one end of the fabric belt 1 is pulled outwards and disconnected from the strips of hook material 31 at the front side of cellular telephone 4. A prototype of crystallite covering has been constructed with the features of FIGS. 1˜3. The crystallite covering functions smoothly to provide all of the features discussed earlier.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A crystallite covering used with a cellular telephone to isolate electromagnetic waves of said cellular telephone from contacting the user, comprising a flexible fabric belt adapted to cover front and back sides of said cellular telephone, said flexible fabric belt comprising a plurality of crystallites of different sizes fixedly fastened to a front sidewall thereof and arranged to show different designs.

2. The crystallite covering of claim 1 wherein said crystallites include big crystallites respectively disposed at topside around the antenna of said cellular telephone.

3. The crystallite covering of claim 1 wherein said flexible fabric belt comprises a plurality of narrow strips of loop material fixedly transversely disposed at a back sidewall thereof and adapted to engage respective strips of hook material being fixedly fastened to front and back sides oft said cellular telephone.
